(19) United States
(12) Patent Application Publication
(10) Pub. No.: US 2008/0060536 A1
(43) Pub. Date: Mar. 13, 2008

(54) Printing screen and method

(75) Inventor: Cory M. Holda, Colorado Springs, CO (US)

Correspondence Address: LAW OFFICE OF DALE B. HALLING, LLC, 655 SOUTHPOINTE CT, SUITE 100, COLORADO SPRINGS, CO, 80906, US

(73) Assignee: Cory M. Holda

(21) Appl. No.: 11/519,325

(22) Filed: Sep. 12, 2006

(51) Int. Cl. B41C 1/14

(52) U.S. Cl. 101/128.4

(57) ABSTRACT

A printing screen has a first metallic layer that is electroformed and has a number of apertures in the metallic layer. A second metallic layer is electroformed over the first metallic layer. The second metallic layer forms a frame around groups of the apertures.

### RELATED APPLICATIONS

None.

### FIELD OF THE INVENTION

The present invention relates generally to the field of screens and more particularly to a printing screen and method.

### BACKGROUND OF THE INVENTION

In the electronics industry screen printing is used to make various components. For example, microelectronic packages called hybrids, or multi-chip modules, utilize circuits and electrical devices made by screen printing. Conductive, resistive and dielectric patterns of a circuit can be formed by screen printing onto a rigid substrate such as a circuit board. Screen printing is also used in the fabrication of field emission displays (FEDs) for flat panel displays. With a FED, the normal topography used to make a hybrid can be multi level due to the gap which is required between the anode and cathode components of the display. This places some additional demands on the screen printing process.

Screen printing for microelectronics is similar to the method used to make t-shirts and printed panels for industrial equipment but at the high end of the technology. A typical screen printing process for a multi level hybrid would be to print a conductive layer, dry the layer and fire. The substrate would then be processed with the next layer, usually a dielectric composition. After dry and fire another layer of conductor would be fired.

With screen printing, a screen is used to deposit a thick-film paste, or other printing material, onto a substrate (e.g., polyimide circuit board, silicon baseplate). Different techniques are used to transfer the desired pattern from a mask containing artwork to the screen.

To produce a screen, a stainless steel or monofilament polyester screen mesh is stretched and attached to a metal frame. A negative pattern must then be generated on the mesh so that the printing material can be forced through the screen to produce a positive pattern for the substrate. A photosensitive emulsion can be used to make the negative pattern on the screen. For screen printing the pattern defined by the patterning layer onto a substrate, the substrate is secured to a support platform within a screen printer. The screen is mounted within the screen printer, parallel to the substrate but spaced apart from the substrate with a slight gap. The printing material is then applied to the screen and a squeegee (e.g., rubber blade) is moved across the screen at a constant rate. The squeegee forces the printing material through the open areas of the screen and prints the pattern defined by the patterning layer onto the substrate.

For printing small closely spaced features, fine mesh screens are preferred. One problem with the screen printing of patterns having small closely spaced features, is that the resolution and spacing of the features of the pattern can be adversely affected by the screen wires. In particular, with a pattern having feature sizes approximately equal to the size of the openings in the mesh, the resolution and spacing of the features can be distorted by the screen wires.

Another limitation of screens formed for screen printing occurs during the development of the photosensitive emulsion which forms the patterning layer. During a development step, the unexposed material for a negative emulsion, or the exposed material for a positive emulsion, must be cleared from the screen. Clearing out this material is complicated by the presence of the screen wires. Consequently, if the material is not completely cleared, pattern defects can occur.

Another limitation of present screens is that the screen pattern stretches after several prints. The interwoven mesh wires can stretch during use and cause mismatches between the pattern and the desired deposit location.

Thus there exists a need for a printing screen that is capable of printing fine features, does not stretch and is reliable.

### SUMMARY OF INVENTION

A printing screen that overcomes these and problems has a first metallic layer that is electroformed and has a number of apertures in the metallic layer. A second metallic layer is electroformed over the first metallic layer. The second metallic layer forms a frame around groups of the apertures. The frame side of the resulting screen is placed against the surface to be printed. Since the frame holds the apertures off the surface to be printed the solder paste does not adhere to the apertures. This printing screen is inexpensive to manufacture and allows for fine pitch apertures. In this invention the screen mesh wires are replaced with electroformed openings. These solid electroformed openings will not stretch with use (printing).

### BRIEF DESCRIPTION OF THE DRAWINGS

FIG. 1 is a bottom view of a printing screen in accordance with one embodiment of the invention;

FIG. 2 is a cross sectional view of a printing screen in accordance with one embodiment of the invention; and

FIG. 3 is a flow chart of the steps used in manufacturing a printing screen in accordance with one embodiment of the invention.

### DETAILED DESCRIPTION OF THE DRAWINGS

The present invention is directed to a printing screen for electronic circuits. The improved printing screen uses a two step electroforming process. The first metallic layer defines a plurality of apertures. The second metallic layer creates a frame around groups of the apertures. The process of producing the screen is inexpensive, can produce fine pitch apertures, does not stretch with use and does not result in the solder paste adhering to the apertures.

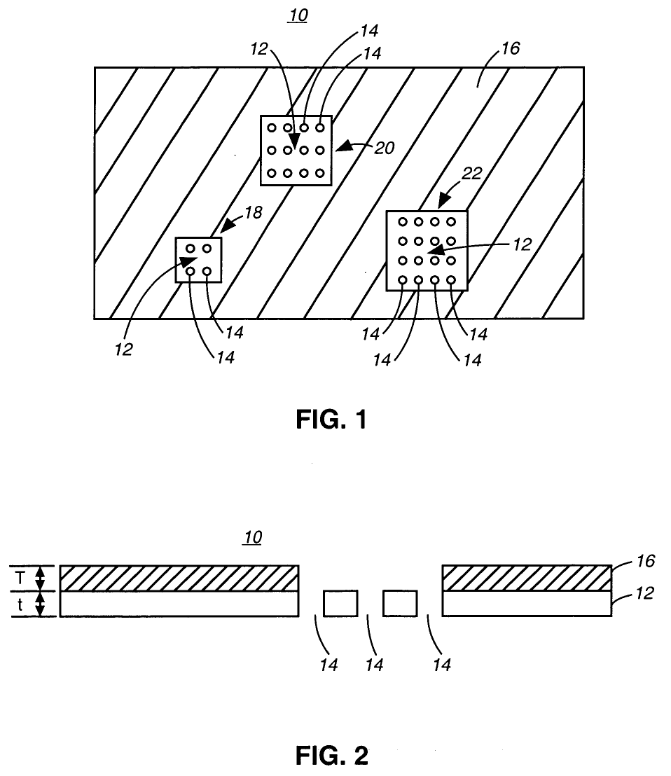

FIG. 1 is a bottom view of a printing screen 10 in accordance with one embodiment of the invention. The screen 10 has a first metallic layer 12 which is electroformed with a plurality of apertures or orifices 14. A second metallic layer 16 is electroformed on the first metallic layer and creates a frame around a group 18, 20, 22 of apertures. In one embodiment, a group of apertures is defined as a number of closely spaced apertures. FIG. 2 is a cross sectional view of the printing screen 10 in accordance with one embodiment of the invention. The first metallic layer 12 defines a plurality of apertures 14. A second metallic layer 16 defines a frame around a group of apertures. The second metallic layer 16 is electroformed onto the first metallic layer 12. The first metallic layer has a thickness of “t” and the second metallic layer has a thickness of “T”. In one embodiment, the thickness “t” of the first metallic layer is less than or equal to the thickness “T” of the second metallic layer. Note that a group of apertures may be a single aperture.

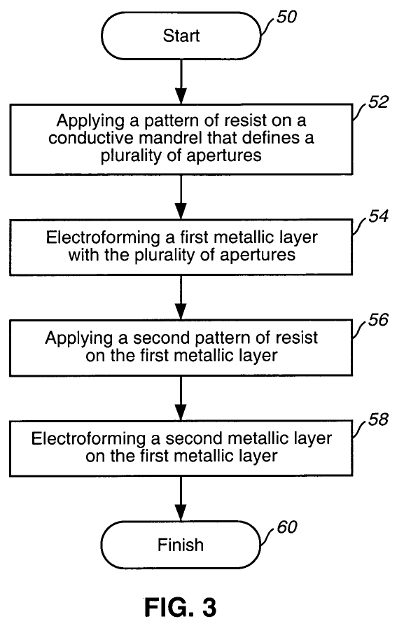

FIG. 3 is a flow chart of the steps used in manufacturing a printing screen in accordance with one embodiment of the invention. The process starts, step 50, by applying a pattern of resist on a conductive mandrel that defines a plurality of apertures 52. Next the first metallic layer is electroformed with the plurality of apertures at step 54. A second pattern of resist is applied on the first metallic layer at step 56. At step 58 the second metallic layer is electroformed on the first metallic layer which ends the process at step 60. In one embodiment, the second metallic layer forms a frame around a group of apertures.

Thus there has been described a printing screen that is reliable, does not stretch with use and allows for fine pitch apertures without the solder paste adhering to the apertures.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A printing screen comprising:
a first metallic layer electroformed having a plurality of apertures; and
a second metallic layer electroformed to the first metallic layer, the second metallic layer creating a frame around a group of the plurality of apertures.

2. The printing screen of claim 1, wherein the group of the plurality of apertures is a number of closely spaced apertures.

3. The printing screen of claim 2, wherein the plurality of apertures form at least two groups.

4. The printing screen of claim 1, wherein a thickness of the second metallic layer is equal to or greater than a thickness of the first metallic layer.

5. A method of forming a printing screen, comprising the steps of:
a) applying a pattern of resist on a conductive mandrel that defines a plurality of apertures;
b) electroforming a first metallic layer with the plurality of apertures; and
c) applying a second pattern of resist on the first metallic layer.

6. The method of claim 5, further including the step of:
d) electroforming a second metallic layer on the first metallic layer.

7. The method of claim 6, wherein step (d) further includes the step of electroforming a frame around a group of the plurality of apertures.

8. The method of claim 5, wherein step (c) further includes the step of defining a frame around a group of the plurality of apertures with the second pattern of resist.

9. A printing screen comprising:
a first electroformed metallic layer having a plurality of orifices; and
a second metallic layer electroformed to the first electroformed metallic layer.

10. The screen of claim 9, wherein the second metallic layer forms a frame around a group of the plurality of orifices.

11. The screen of claim 10, wherein the plurality of orifices form at least two groups.

12. The screen of claim 11, wherein a thickness of the first electroformed metallic layer is less than or equal to a thickness of the second metallic layer.
